(19) United States
(12) Patent Application Publication
(10) Pub. No.: US 2012/0297319 A1
(43) Pub. Date: Nov. 22, 2012

(54) Solutions Configurator

(76) Inventor: Christopher Craig Collins, Round Rock, TX (US)

(21) Appl. No.: 13/112,159

(22) Filed: May 20, 2011

(51) Int. Cl. G06F 3/01

(52) U.S. Cl. 715/753

(57) ABSTRACT

A system and method are disclosed for collaboratively configuring an information handling system (IHS). Collaborative IHS configuration operations are initiated by a first user selecting an IHS product to collaboratively configure. The first user selects one of more additional users for collaboration. The current product configuration, along with configuration options for each of the components of the selected IHS product, is then respectively displayed within a user interface (UI) for each of the users. Collaborative product configuration modification operations are then interactively performed by the users. The modified configuration is then saved as a unique configuration of the IHS product.

### BACKGROUND OF THE INVENTION

1. Field of the Invention

Embodiments of the invention relate generally to information handling systems. More specifically, embodiments of the invention provide a system and method for collaboratively configuring an information handling system.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In a build-to-order (BTO) manufacturing process, an information handling system is built to a customer's specification from a range of available options. During this process, customization and configuration of the system typically occurs by the customer selecting various hardware and software components for installation when the system is manufactured. For example, the hardware components selected by the customer may include cabinets, racks, processors, system memory, mass storage units, controllers, cooling systems, and power management subsystems. Likewise, the customer may select a variety of graphics, network, and expansion cards to address various operational requirements.

Due of the number and variety of components that are available for installation, manufacturers of information handling systems typically develop an extensive and complex set of configuration rules. One known approach to the use of such rules is the implementation of a configuration system that employs dependent variables that are linked to, or associated with, certain components. For example, if the system is configured to include component ‘X’, then component ‘Y’ must also be installed. In another known approach, the configuration of the system is determined by its intended purpose, function or use. However, such a functional approach does not necessarily determine the physical location of individual components within the system. Instead, it only defines their various functions.

Yet another known approach is to combine various constraint-based and functional approaches to define a configuration that is logical and generates a relationship between individual components and their physical location. Such a combination attempts to define a configuration by defining the functions of the components and the constraints according to the identity, and associated constraints and characteristics, of individual system components. However, this sort of an approach can prove problematic in that it does not necessarily identify a suitable location for the placement of each component within the computer system. Furthermore, no known configuration system provides the ability for individual users to collaborate in the configuration of an information handling system, either asynchronously or in real-time.

### SUMMARY OF THE INVENTION

A system and method are disclosed for collaboratively configuring an information handling system (H-IS). In various embodiments, a collaborative configuration system is implemented with repositories of product configuration data and system configuration data to support collaborative IHS configuration operations. In these and other embodiments, collaborative IHS configuration operations are initiated by a first user, such as a customer, who then selects an IHS product to collaboratively configure. In various embodiments, the configuration of the IHS product is stored in the repository of system configuration data. In various other embodiments, the configuration of the IHS product is stored in the repository of product configuration data.

The first user then selects one of more additional users for collaboration. In various embodiments, the one or more additional users may be a customer of the IHS manufacturer, a third party acting on behalf of the customer, an employee of the manufacturer, or a third party acting on behalf of the manufacturer. Thereafter, the current product configuration(s), along with configuration options for each of the components of the selected IHS product, are respectively displayed within the collaborative configuration system user interface (UI) for each of the users. In various embodiments, the configuration options include data corresponding to each component's performance, power consumption, heat dissipation, noise level, weight, physical dimensions, and pricing.

Collaborative product configuration modification operations are then interactively performed by the users. In one embodiment, the collaborative product configuration operations are performed asynchronously by the individual users. In another embodiment, the collaborative product configuration modification operations are performed contemporaneously by the individual users. In various embodiments, the respective configuration modifications are viewable with each user's collaborative configuration system UI. In one embodiment, the modified configuration is saved as a unique configuration in the repository of system configuration data. In various embodiments, the original configuration and the modified configuration are displayed concurrently within the collaborative configuration system UI of each user. In one embodiment, differences between original and modified configurations are emphasized through the application of visual attributes.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized illustration of the components of an information handling system as implemented in the system and method of the present invention;

FIG. 2 is a simplified block diagram showing an implementation of a collaborative configuration system;

FIG. 3 is a generalized flow chart of the operation of collaborative configuration system; and

FIG. 4 is a generalized depiction of collaborative configuration system as implemented within a window of a user interface.

### DETAILED DESCRIPTION

A system and method is disclosed for collaboratively configuring an information handling system. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

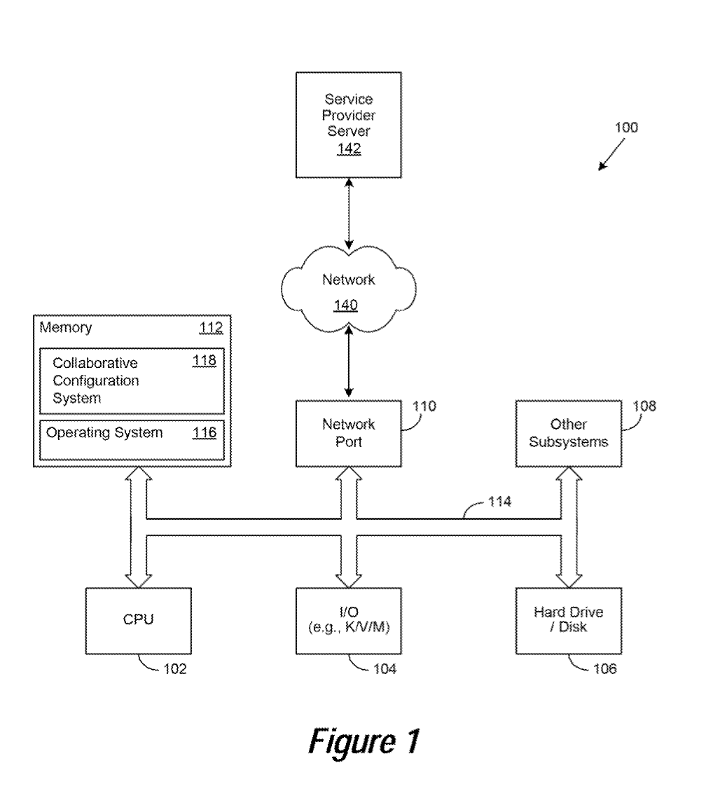

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and a Web browser 126. In various embodiments, the system memory 112 may also comprise a collaborative configuration system 118. In one embodiment, the information handling system 100 is able to download the Web browser 126 and the collaborative configuration system 118 from the service provider server 142. In another embodiment, the collaborative configuration system 118 is provided as a service from the service provider server 142.

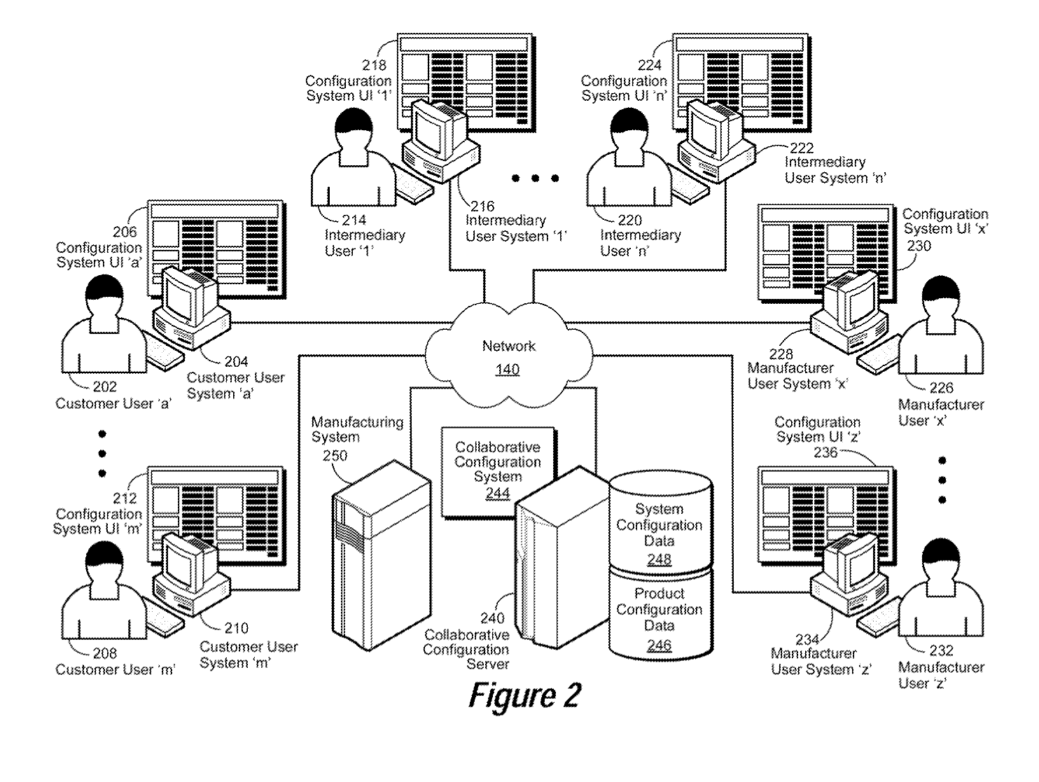

FIG. 2 is a simplified block diagram showing an implementation of a collaborative configuration system in accordance with an embodiment of the invention, In this embodiment, a collaborative configuration system (“configuration system”) 244 is implemented on a collaborative configuration server 240, which comprises a repository of product configuration data 246 and a repository of system configuration data 248. As shown in FIG. 2, a configuration system user interface (UI) ‘a’ 206 through ‘m’ 212 are respectively implemented on customer user systems ‘a’ 204 through ‘m’ 210, which are associated with customer users ‘a’ 202 through ‘m’ 208. Likewise, a configuration system UI ‘1’ 218 through ‘n’ 224 are respectively implemented on intermediary user systems ‘1’ 216 through ‘n’ 220, which are associated with intermediary users ‘1’ 214 through ‘n’ 220. In various embodiments, the intermediary users ‘1’ 214 through ‘n’ 220 may be a third party acting on behalf of the customer or the manufacturer of an information handling system (IHS). As likewise shown in FIG. 2, a configuration system UI ‘x’ 230 through ‘z’ 234 are respectively implemented on manufacturer user systems ‘x’ 228 through ‘z’ 234, which are associated with manufacturer users ‘x’ 226 through ‘z’ 232.

In this embodiment, collaborative IHS configuration operations are initiated by a first user, such as customer users ‘a’ 202 through ‘m’ 208, initiating a collaborative configuration session with the configuration system 244 over a connection to network 140. Once the collaborative IHS configuration session is initiated, the first user then selects an IHS product to collaboratively configure. In various embodiments, the configuration of the IHS product is stored in the repository of system configuration data 248. In various other embodiments, the configuration of the IHS product is stored in the repository of product configuration data 246.

The first user then selects one of more additional users for collaboration. In various embodiments, the one or more additional users may be selected from customer users ‘a’ 202 through ‘m’ 208, intermediary users ‘1’ 214 through ‘n’ 220, or manufacturer users ‘x’ 226 through ‘z’ 232. Thereafter, the current product configuration(s), along with configuration options for each of the components of the selected IHS product, are respectively displayed within the collaborative configuration system UI (e.g., configuration system UIs ‘a’ 206 through ‘m’ 212, ‘1’ 218 through ‘n’ 224, or ‘x’ 230 through ‘z’ 234) for each of the users. In various embodiments, the configuration options include data corresponding to each component's performance, power consumption, heat dissipation, noise level, weight, physical dimensions, and pricing.

Collaborative product configuration modification operations are then interactively performed by the users. In one embodiment, the collaborative product configuration operations are performed asynchronously by the individual users. For example, different users may make their respective configuration changes individually and at different times. In another embodiment, the collaborative product configuration modification operations are performed contemporaneously by the individual users. As an example, the individual users may be geographically dispersed, but collaboratively perform their respective configuration modifications at the same time during a teleconference or a Voice Over Internet Protocol (VOIP) connection. In various embodiments, the respective configuration modifications are viewable with each user's collaborative configuration system UI (e.g., configuration system UIs ‘a’ 206 through ‘m’ 212, ‘1’ 218 through ‘n’ 224, or ‘x’ 230 through ‘z’ 234).

In one embodiment, the modified configuration is saved as a unique configuration in the repository of system configuration data 248. For example, the originally selected IHS product may be referred to as “Application Server Configuration A.” After various configuration modification operations have been performed, the resulting configuration may be saved in the collaborative configuration system as “Application Server Configuration B.” In various embodiments, the original configuration and the modified configuration are displayed concurrently within the collaborative configuration system UI of each user (e.g., configuration system UIs ‘a’ 206 through ‘m’ 212, ‘1’ 218 through ‘n’ 224, or ‘x’ 230 through ‘z’ 234). In one embodiment, the modified configuration is communicated from the collaborative configuration system 244 to the manufacturing system 250 over a connection to the network 140. Once received, the manufacturing system uses the modified configuration to manufacture an information handling system.

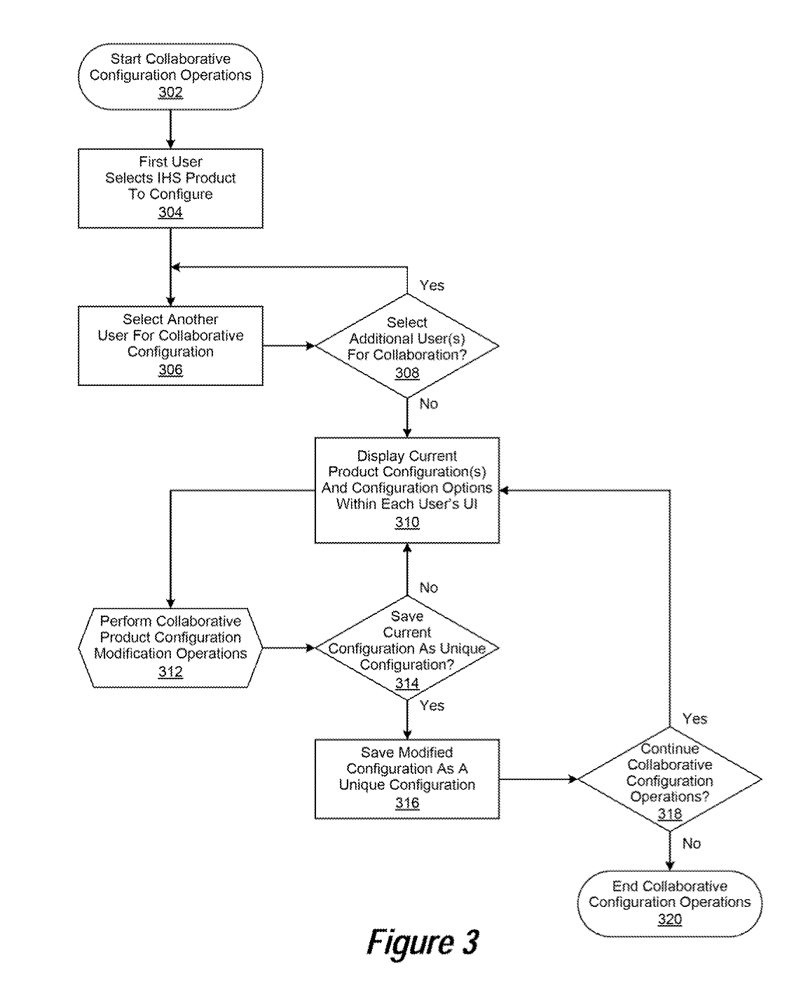

FIG. 3 is a generalized flow chart of the operation of collaborative configuration system as implemented in accordance with an embodiment of the invention. In this embodiment, collaborative information handling system (IHS) configuration operations are begun in step 302, followed by a first user selecting an IHS product to collaboratively configure. The first user then selects another user for collaboration in step 306, followed by making a determination in step 308 whether additional users are to be selected for the collaborative configuration of the IHS system. In various embodiments, the individual users may be a customer of the IHS manufacturer, a third party acting on behalf of the customer, an employee of the manufacturer, or a third party acting on behalf of the manufacturer. Those of skill in the art will realize that many such examples of users are possible and that the foregoing is not intended to limit the spirit, scope, or intent of the invention.

If it is determined in step 308 to select additional users, then the process is continued, proceeding with step 306. Otherwise, the current product configuration(s), along with configuration options for each of the components of the IHS product, are respectively displayed within a collaborative configuration system user interface (UI) for each of the users. In various embodiments, the configuration options include data corresponding to each component's performance, power consumption, heat dissipation, noise level, weight, physical dimensions, and pricing.

Collaborative product configuration modification operations are then performed in step 312 as described in greater detail herein. A determination is then made in step 314 whether to save the modified configuration as a unique configuration as likewise described in greater detail herein. If it is determined in step 314 not to save the current configuration as a unique configuration, then the process is continued, proceeding with step 310. Otherwise, the modified configuration is saved as a unique configuration in step 316. A determination is then made in step 318 whether to continue collaborative IHS system configuration operations. If so, then the process is continued, proceeding with step 310. Otherwise collaborative IHS system configuration operations are ended in step 320.

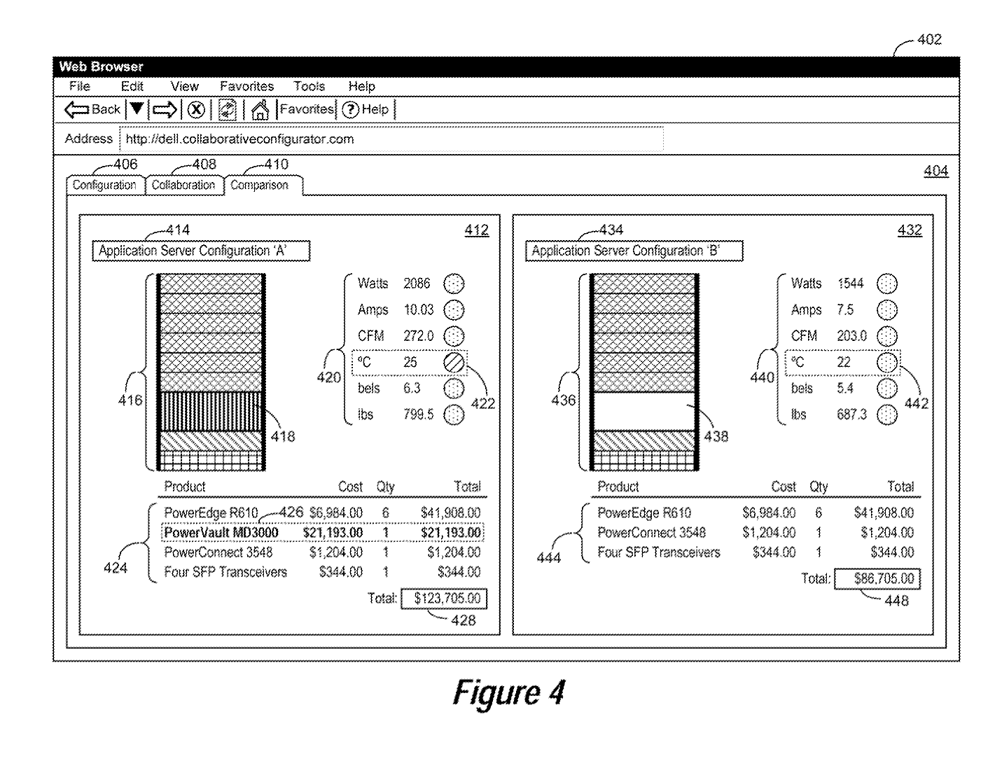

FIG. 4 is a generalized depiction of collaborative configuration system as implemented within a window of a user interface in accordance with an embodiment of the invention. In this embodiment, a collaborative configuration system, as described in greater detail herein, is implemented within a window 404 of a user interface (UI), such as a UI for a web browser 402. As shown in FIG. 4, the UI window 404 comprises ‘Configuration’ 406, ‘Collaboration’ 408, and ‘Comparison’ 410 tabs. As likewise shown in FIG. 4, the ‘Comparison’ 410 tab comprises two sub-windows 412 and 432 which respectively comprise different configurations of an information handling system (IHS), “Application Server Configuration A” 414 and Application Server Configuration B″ 434.

The two sub-windows 412 and 432 likewise respectively comprise graphical representations 416 and 436 of the two IHS configurations, which in turn correspond to their respective component configuration information 424 and 444. As shown in FIG. 4, “Application Server Configuration A” 416 comprises six (6) “PowerEdge R610” units, a “PowerVault MD3000” unit, a “PowerConnect 3548” unit, and a “Four SFP Transceivers” unit, with a total price 428 of “$123,705.00.” Likewise, “Application Server Configuration B” 436 comprises six (6) “PowerEdge R610” units, a “PowerConnect 3548” unit, and a “Four SFP Transceivers” unit, with a total price 448 of “$86,705.00.”

Likewise, the two sub-windows 412 and 432 respectively comprise operational and other component information 420 and 440 related to “Application Server Configuration A” 412 and “Application Server Configuration B” 434. In various embodiments, the operational and other component information comprises performance, power consumption, heat dissipation, noise level, weight, and physical dimension data. In these and various other embodiments, differences between the two configurations are visually indicated. For example, as shown in FIG. 4, “Application Server Configuration A” 412 has a total heat dissipation of “25 degrees Celsius,” which is graphically indicated 422 to be in excess of an acceptable limit. In contrast, “Application Server Configuration B” 434 has a total heat dissipation 442 of “22 degrees,” which is graphically indicated 442 to be within acceptable limits. Likewise, in contrast to “Application Server Configuration B” 434, “Application Server Configuration A” 416 is graphically represented to comprise a “PowerVault MD3000” 418 unit, which is also visually indicated 426 within component configuration information 424. As shown in FIG. 4, the absence of a “PowerVault MD3000” 438 unit is graphically represented in “Application Server Configuration B” 436.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A system for collaboratively configuring an information handling system, comprising:
a repository of product configuration data;
a first configuration of an information handling system, the first configuration comprising a first set of product configuration data;
a user interface configured to display the first configuration and further configured to receive a first set of user input data corresponding to a first set of configuration modification data and a second set of user input data corresponding to a second set of configuration modification data, the first and second sets of user input data respectively corresponding to a first and second user; and
processing logic configured to process the first and second sets of product configuration modification data to generate a second configuration of the IHS, the second configuration displayed within the user interface and comprising a second set of product configuration data.

2. The system of claim 1, wherein the first and second configurations are displayed concurrently within the user interface.

3. The system of claim 1, wherein the first and second sets of user input data are received asynchronously.

4. The system of claim 1, wherein the first and second sets of user input data are received contemporaneously.

5. The system of claim 1, wherein the first and second users respectively comprise at least one of the set of:
a customer;
a third party acting on behalf of a customer;
an employee of the manufacturer of the information handling system; and
a third party acting on behalf of the manufacturer of the information handling system.

6. The system of claim 1, wherein the first and second sets of product configuration data respectively correspond to a first and second set of information handling system component data.

7. The system of claim 6, wherein the first and second sets of information handling system component data comprise at least one of the set of:
performance data;
power consumption data;
heat dissipation data;
noise level data;
weight data;
physical dimension data; and
pricing data.

8. The system of claim 7, wherein the first and second sets of information handling system component data are concurrently displayed within the user interface.

9. The system of claim 1, wherein the first and second sets of product configuration data respectively comprise a first and second price for the first and second configurations.

10. The system of claim 1, wherein differences between the first and second configurations are visually indicated within the user interface.

11. A computer-implementable method for collaboratively configuring an information handling system, comprising:
using a repository of product configuration data;
using a first configuration of an information handling system, the first configuration comprising a first set of product configuration data;
using a user interface configured to display the first configuration and further configured to receive a first set of user input data corresponding to a first set of configuration modification data and a second set of user input data corresponding to a second set of configuration modification data, the first and second sets of user input data respectively corresponding to a first and second user; and
using processing logic to process the first and second sets of product configuration modification data to generate a second configuration of the IHS, the second configuration displayed within the user interface and comprising a second set of product configuration data.

12. The method of claim 11, wherein the first and second configurations are displayed concurrently within the user interface.

13. The method of claim 11, wherein the first and second sets of user input data are received asynchronously.

14. The method of claim 11, wherein the first and second sets of user input data are received contemporaneously.

15. The method of claim 11, wherein the first and second users respectively comprise at least one of the set of:
a customer;
a third party acting on behalf of a customer;
an employee of the manufacturer of the information handling system; and
a third party acting on behalf of the manufacturer of the information handling system.

16. The method of claim 11, wherein the first and second sets of product configuration data respectively correspond to a first and second set of information handling system component data.

17. The method of claim 16, wherein the first and second sets of information handling system component data comprise at least one of the set of:
performance data;
power consumption data;
heat dissipation data;
noise level data;
weight data;
physical dimension data; and
pricing data.

18. The method of claim 17, wherein the first and second sets of information handling system component data are concurrently displayed within the user interface.

19. The method of claim 11, wherein the first and second sets of product configuration data respectively comprise a first and second price for the first and second configurations.

20. The method of claim 11, wherein differences between the first and second configurations are visually indicated within the user interface.
